(19) United States
(12) Patent Application Publication
(10) Pub. No.: US 2017/0293103 A1
(43) Pub. Date: Oct. 12, 2017

(54) PLASTIC LENS, METHOD OF MANUFACTURING THE SAME, AND OPTICAL INSTRUMENT

(71) Applicant: CANON KABUSHIKI KAISHA, Tokyo (JP)

(72) Inventor: Atsushi Shinohara, Inashiki-gun (JP)

(21) Appl. No.: 15/480,023

(22) Filed: Apr. 5, 2017

(30) Foreign Application Priority Data
Apr. 8, 2016 (JP) 2016-078358

(51) Int. Cl. G02B 7/02; B29C 45/00; G02B 13/00; B29D 11/00

(52) U.S. Cl. CPC G02B 7/02; B29D 11/00009; B29C 45/0055; G02B 13/001; B29L 2011/0016

(57) ABSTRACT

A lens portion, a rib portion formed outside the lens portion, and a protruding portion protruding outward from a part of the rib portion are included, and the thickness of the rib portion is 1.4 times or more the thickness of an aperture end of a lens surface of the lens portion.

### BACKGROUND OF THE INVENTION

### Field of the Invention

The present disclosure relates to a lens used in optical instruments such as a camera, a video, and an optical pickup device. The present disclosure especially relates to a plastic lens having a diameter of 10 mm or less (the plastic lens may be referred to as small-diameter plastic lens in the present specification).

### Description of the Related Art

A small-diameter plastic lens manufactured by injection molding often have a difficulty in release from a mold and assembly work to a lens barrel due to its small size.

Conventional technologies disclose an idea to remove the lens from the mold, a lens shape for making the assembly work to the lens barrel easy, and the like.

For example, Japanese Patent Laid-Open No. 2010-12693 discloses a technique to push a protruding portion connected to a product portion, a runner portion, and a sprue portion by ejector pins, push the product portion with an insert, stop the insert after releasing the molded product, and then further operate the ejector pins to take out the product portion from the insert.

In an injection molding mold used to manufacture the small-diameter plastic lens by injection molding, a highly accurately machined piece (may be referred to as mirror surface piece in the present specification) is arranged in the mold to mold an optical surface of the lens. This mirror surface piece is mainly produced by turning machining. The mirror surface piece may sometimes be produced by a method called fly cutting in which the piece is machined with a turning edged tool. However, in the case of the small-diameter plastic lens, production by the fly cutting is often difficult because the diameter of the mirror surface piece is small and a machining radius is very small depending on optical design. On the other hand, in the case of the turning machining, the mirror surface piece is rotated along an optical axis and the edged tool is brought in contact with the piece to machine the piece. Therefore, surfaces symmetric to a rotation axis can be easily machined, and a machining speed is fast.

However, in injection-molding the plastic lens, even if the mirror surface piece, which has been highly accurately machined according to an optical design value, is used, a desired lens cannot be obtained due to contraction behavior of plastic. It is typical to perform correction machining in consideration of an error amount from the design value of the plastic lens in addition to a machining amount of the mirror surface piece. As described above, since the turning machining is axisymmetric machining, a non-axisymmetric shape error cannot be corrected. Therefore, it is necessary to set a molding condition and the like to make a non-axisymmetric component of the molded product shape error small.

A cause of occurrence of the non-axisymmetric molded product shape error includes mold release force and mold release resistance not occurring in an axisymmetric manner. Here, a cross-sectional view of the injection molding mold according to the conventional technology described in Japanese Patent Laid-Open No. 2010-12693 is illustrated in FIG. 8. Further, a cross-sectional view of the plastic lens molded with the mold is illustrated in FIG. 9.

The mold has a structure in which a product portion 81 is pressed by a movable-side mirror surface piece 83, a portion to be pressed 82 connected to the product portion 81 is pressed by an ejector pin 84, and a runner portion is pressed by an ejector pin 86. However, in this structure, the thickness of a flange portion 88 of the lens is thin, and the thickness of the portion to be pressed 82 is the same as the thickness of the flange portion 88. Therefore, the flange portion 88 and the portion to be pressed 82 are easily deformed. Therefore, bending moment, which occurs due to pressing of the ejector pins, has an influence up to an optical effective portion 89 of the lens, and incurs deterioration of surface accuracy of the lens. Further, the portion to be pressed 82 pressed by the ejector pin 84 is provided only in one place on an opposite gate side that is opposite to a gate, and the mold release force occurs only in a direction toward the opposite gate side from the runner portion, even combined with the ejector pin 86 that presses the runner portion. Therefore, in the molded product shape error, the error amount differs between in the direction toward the opposite gate side from the runner portion and a direction perpendicular to the aforementioned direction, and the correction cannot be made by the turning machining.

### SUMMARY OF THE INVENTION

Therefore, an aspect of the present disclosure provides a lens having a small non-axisymmetric component of a molded product shape error, and having no influence of the non-axisymmetric mold release force and mold release resistance up to a molded product optical surface.

A plastic lens of the present disclosure includes a lens portion, a rib portion formed outside the lens portion, and a protruding portion protruding outward from a part of the rib portion, wherein the thickness of the rib portion is 1.4 times or more the thickness of an aperture end of a lens surface of the lens portion.

A method of manufacturing a plastic lens of the present disclosure includes bringing a fixed-side piece and a movable-side piece, in which a shape for transferring the plastic lens is formed, to face each other to form a cavity, and injecting a resin into the cavity to mold the plastic lens.

According to the plastic lens of the present disclosure, a rib shape thicker than the aperture end of the lens surface is included between the protruding portion and the flange shape. Therefore, even if the non-axisymmetric mold release force or mold release resistance occurs outside the rib shape, an influence on an optical surface existing inside the rib can be made small.

Further features of the present disclosure will become apparent from the following description of exemplary embodiments (with reference to the attached drawings).

### BRIEF DESCRIPTION OF THE DRAWINGS

FIG. 1 illustrates a lens perspective view of the present disclosure.

FIG. 2 illustrates an injection molding mold cross-sectional view used in the present disclosure.

FIG. 3 illustrates a lens cross-sectional view in a first exemplary embodiment of the present disclosure.

FIGS. 4A to 4C illustrate states of a resin flow in the first exemplary embodiment of the present disclosure.

FIGS. 5A to 5C illustrate states of the resin flow in the first exemplary embodiment of the present disclosure.

FIG. 6 illustrates a diagram illustrating measuring directions at the time of lens evaluation.

FIG. 7 illustrates a lens cross-sectional view in a second exemplary embodiment of the present disclosure.

FIG. 8 illustrates an injection molding mold cross-sectional view according to a conventional technology.

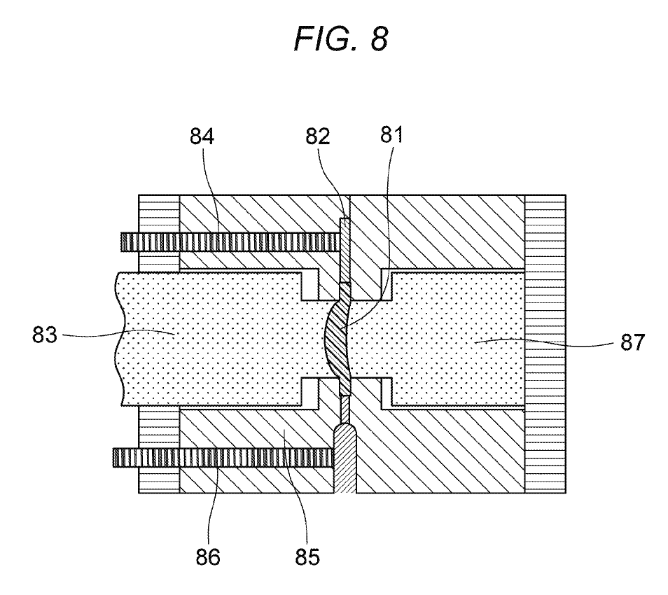

FIG. 9 illustrates a lens cross-sectional view according to the conventional technology.

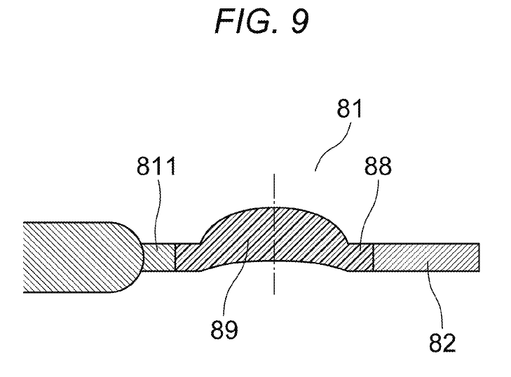

### DESCRIPTION OF THE EMBODIMENTS

### First Exemplary Embodiment

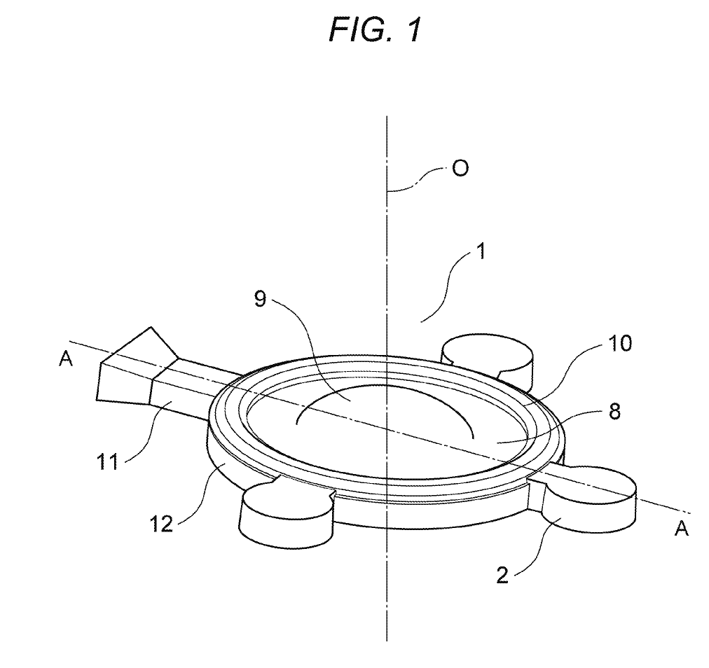

FIG. 1 is a perspective view of a plastic lens 1 in a first exemplary embodiment of the present disclosure. Such a plastic lens is manufactured by injection molding. As the material, ZEONEX E48R (registered trademark) manufactured by Zeon Corporation, Yupizeta (registered trademark) manufactured by Mitsubishi Gas Chemical Company, Inc., OKP (registered trademark) manufactured by Osaka Gas Chemicals Co., Ltd., or the like can be used.

FIG. 1 illustrates a lens portion 9, a flange portion 8, a rib portion 10, a protruding portion 2, a gate mark 11, and an outer peripheral surface 12 of the rib portion 10. That is, the shape of the plastic lens 1 of the first exemplary embodiment of the present disclosure has a configuration in which the flange portion 8 exists around the lens portion 9, the rib portion 10 exists outside the flange portion 8, and the protruding portion 2 exists outside the rib portion 10. However, the shape is not limited thereto, and for example, the flange portion 8 between the lens portion 9 and the rib portion 10 may not be included. Further, a flange portion (not illustrated) may exist between the rib portion 10 and the protruding portion 2. Further, the flange portion 8 may also exist between the lens portion 9 and the rib portion 10, and the flange portion (not illustrated) may also exist between the rib portion 10 and the protruding portion 2. In a mold for injection-molding the plastic lens 1, ejector pins are respectively arranged adjacent to spaces for molding the protruding portions 2. Then, in releasing the plastic lens 1 as a molded product from the mold, the plastic lens 1 can be released from the mold by respectively pushing the protruding portions 2 by the ejector pins. Especially, in a case of the plastic lens in which the diameter of the lens portion 9 is 10 mm or less and the minimum thickness is 0.5 mm or less, exertion of the effect of the present disclosure becomes more prominent. The rib portion 10 favorably has an annular shape. If the rib portion 10 has the annular shape, an influence of non-axisymmetric mold release force and mold release resistance can be further suppressed. An optical axis O of the plastic lens passes through the center of the lens portion 9.

One or a plurality of the protruding portions 2 may be included. Each of the protruding portions 2 has a columnar shape with a smaller diameter than the lens portion, and the columnar shape is joined with the rib portion 10. In the present exemplary embodiment, the example of the columnar shape has been described. However, the shape is not limited thereto, and may be a quadrangular columnar shape. Note that the columnar shape can suppress the mold release resistance, and is thus favorable. Further, an area of each of the protruding portions 2, the area being joined with the rib portion 10, is favorably in contact with the rib portion 10 by a length from 3% to 10%, both inclusive, of the length of the rib portion 10 as viewed from the optical axis. In the case where the flange portion (not illustrated) exists between the rib portion 10 and the protruding portion 2, an area of each of the protruding portions 2, the area being joined with the flange portion between the rib portion 10 and the protruding portion 2, is favorably in contact with the flange portion by a length from 3% to 10%, both inclusive, of the length of the flange portion as viewed from the optical axis. Accordingly, the mold release force of the ejector pin can be transmitted to the plastic lens 1 as a molded product, and the length of an outer peripheral surface being in contact with a lens barrel can be sufficiently obtained in assembly of the lens to the lens barrel.

In the present specification, the lens portion 9, the flange portion 8, and the rib portion 10 may be referred to as lens shape portion. Further, a gate mark portion supposed to be a portion of a gate as an inlet for injecting a resin into a cavity formed in the mold for molding the lens shape portion is referred to as gate mark 11. Further, a position axisymmetric to a center of a portion of the gate mark 11, the portion being in contact with the rib portion 10, with respect to the optical axis O, is referred to as opposite gate mark. Further, the protruding portion 2 existing on the opposite gate mark side refers to a center of a portion of the protruding portion 2, the portion being in contact with the rib portion 10, existing on a line vertically intersecting with a line that connects the center of the portion of the gate mark 11, the portion being in contact with the rib portion 10, and the opposite gate mark, or refers to the center of the portion of the protruding portion 2, the portion being in contact with the rib portion 10, existing on the opposite gate mark side with respect to the vertically intersecting line.

The line A-A is a line that connects the center of the portion of the gate mark 11, the portion being in contact with the rib portion 10, and the center of the optical axis, and a line that connects the center of the optical axis and the center of the portion (area) of the protruding portion 2, the portion being in contact with the rib portion 10, as viewed from the optical axis. In the present specification, a direction of the line that connects the center of the portion (area) of the gate mark 11, the portion being in contact with the rib portion 10, and the opposite gate mark may be referred to as gate mark opposite gate mark direction.

A total of three protruding portions 2 is favorably provided, including one protruding portion having, at the opposite gate mark, the center of the portion (area) being in contact with the rib portion 10, and two protruding portions, each of which has the center of the portion being in contact with the rib portion 10 in a direction perpendicular to the gate mark opposite gate mark direction. This is because the lens can be released in a well-balanced manner, combined with the ejector pin that pushes a runner portion. However, the number of the protruding portions 2 in the present disclosure is not limited to three. The number of the protruding portions 2 may be one on the opposite gate mark side, may be two at positions in ±120 degree directions from the gate mark, respectively, or three or more. If the number of the protruding portions 2 is large, the width of the outer peripheral surface 12 where the lens comes in contact with the lens barrel becomes small, and assembly accuracy in assembling the lens into the lens barrel may be decreased. Therefore, attention is required. Further, the protruding portions 2 are not necessarily arranged symmetric to the lens shape portion. However, it is favorable to provide at least one protruding portion 2 on the opposite gate mark side. In the case of the shape having two protruding portions 2 at positions in ±120 degree directions from the gate mark, respectively, and no protruding portion 2 at the opposite gate mark, there is a possibility of occurrence of an air trap described below. Therefore, attention is required.

Further, the flange portion 8 may not necessarily exist. In this case, the rib portion 10 is formed immediately outside an outermost edge portion of the lens portion 9, that is, an outermost peripheral portion of a curved surface that configures the lens (the outer most peripheral portion is referred to aperture end of the lens surface in the present specification).

The thickness of the protruding portion 2 may be the same as the thickness of the rib portion 10. However, if the thickness of the protruding portion 2 becomes the thickness of the rib portion 10 or more, a molding cycle may become long. Further, the rib portion is sometimes used for lens interval adjustment at the time of assembly of the lens, and thus if the thickness of the protruding portion 2 is larger than the thickness of the rib portion 10, deterioration of assembly accuracy may be incurred due to interference with other parts.

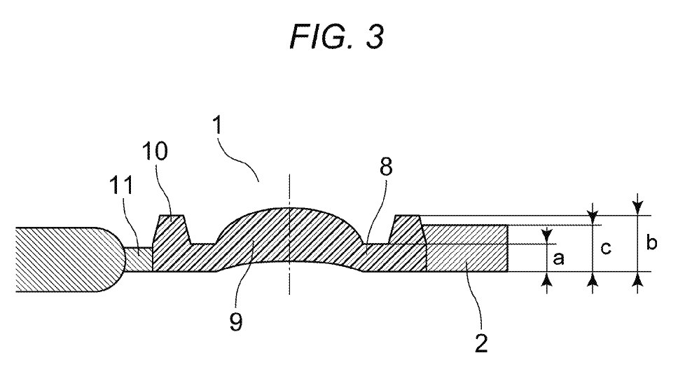

In the present exemplary embodiment, the example in which the lens portion 9 is a convex meniscus lens has been described. However, the lens portion 9 may be a convex lens, a concave lens, or a concave meniscus lens. A schematic diagram of the A-A cross section in FIG. 1 is illustrated in FIG. 3. It is favorable to set dimensions to satisfy the condition below:

b≧1.4a (1)

where the thickness of the aperture end of the lens surface is a, the thickness of the rib shape is b, and the thickness of the protruding portion is c.

When the molded product is released from the mold, the protruding portion 2 and the runner portion are pressed by the ejector pin from an upper side in FIG. 3. Since a mold releasing unit is not provided in the lens portion and the rib portion, resistance force occurs in mold release, and thus bending moment occurs in the molded product. However, if b≧1.4a is satisfied, the rib portion, which is sufficiently thicker than the thinnest portion of the flange portion of the lens, that is, the thickness of the aperture end of the lens surface, surrounds the lens portion. Therefore, the molded product can withstand the bending moment, and deformation can be suppressed. That is, the rib portion prevents deterioration of shape accuracy of the lens surface due to the bending moment. Further, the rib portion may be used as a member for adjusting the lens interval by being brought to butt against a rib portion provided in a next lens in assembling the lens into the lens barrel. Accordingly, an effect to obtain a lens unit that has a highly accurate lens interval and enables easy assembly to a lens barrel can also be expected.

Next, a method of manufacturing the plastic lens in the first exemplary embodiment of the present disclosure will be described.

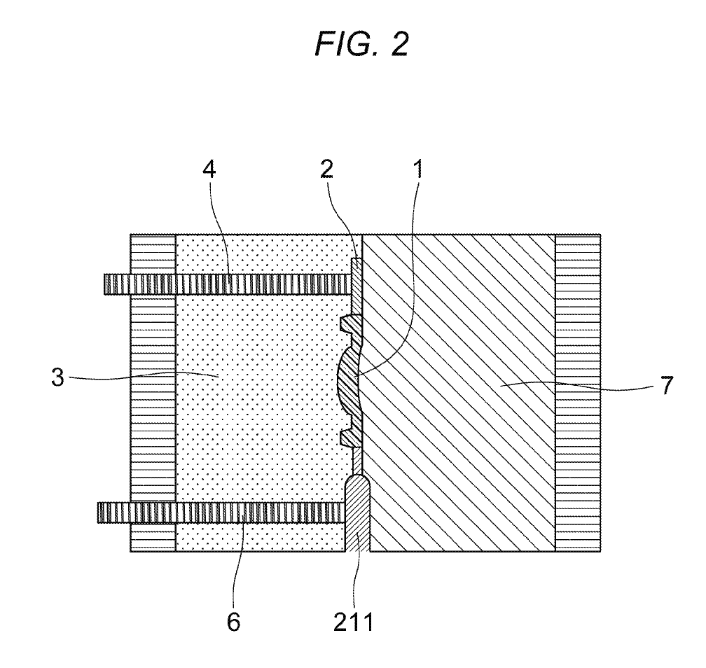

FIG. 2 is a cross-sectional view of the injection molding mold for obtaining the plastic lens in the first exemplary embodiment of the present disclosure. A portion having the same function as that of FIG. 1 is denoted with the same reference sign, and description is omitted. FIG. 2 illustrates a fixed-side piece (may also be referred to as fixed-side mirror surface piece) 7, a movable-side piece (may also be referred to as movable-side mirror surface piece) 3, and ejector pins 4 and 6. The fixed-side mirror surface piece 7 and the movable-side mirror surface piece 3 are machined to have a shape for transferring and molding the lens shape portion (the lens portion, the flange portion, the rib portion, and the outer peripheral surface) by turning machining in which the mirror surface pieces are rotated along the optical axis, and an edged tool is brought in contact with and machines the mirror surface pieces. Machining by the turning machining can suppress exertion of an influence of the non-axisymmetric mold release force and mold release resistance due to the rib portion 10 up to the optical surface of the molded product, and thus a lens having a small non-axisymmetric component of a molded product shape error can be obtained. Further, the shape for molding the optically very important portion of the lens shape portion can be easily machined by the turning machining. Therefore, the plastic lens having axisymmetric and highly accurate optical performance can be molded. Further, the shape for transferring and molding the lens shape portion (the lens portion, the flange portion, the rib portion, and the outer peripheral surface) can be continuously machined with one piece without dividing the shape. If the shape is continuously machined with one piece without division, an effect to easily obtain dimension accuracy as a mold is exerted. That is, with the fixed-side piece 7 and the movable-side piece 3, the shape for transferring and molding the lens portion 9, the flange portion 8, the rib portion 10, and the outer peripheral surface 12, the shape for molding the protruding portions 2, and a gate 211 may be machined with one piece without division. The fixed-side mirror surface piece 7 and the movable-side mirror surface piece 3 are brought to face each other to form a cavity. The cavity is the shape for transferring and molding the lens portion 9, the flange portion 8, the rib portion 10, and the outer peripheral surface 12, the shape for molding the protruding portions 2, and the space for molding the gate 211. Then, the ejector pins 4 and 6 are arranged respectively adjacent to the spaces for molding the protruding portions 2. The resin is injected into the cavity through the gate 211, and the plastic lens is molded. After cured, the mold is opened, the ejector pins are brought to protrude to the molded protruding portions 2, the plastic lens is taken out of the cavity, and the plastic lens is manufactured.

Further, as illustrated in FIG. 3, it is favorable to machine the fixed-side mirror surface piece 7 and the movable-side mirror surface piece 3 so that the molded product satisfies the expression (2) below:

(c−a)≧(b−a)/2 (2)

where the thickness of the aperture end of the lens surface is a, the thickness of the rib shape is b, and the thickness of the protruding portion is c.

If machining is performed using one piece without dividing the shape for molding the lens portion 9, the flange portion 8, the rib portion 10, the outer peripheral surface 12, and the protruding portion 2, and the gate 211, a gap into which a gas (air) existing in the cavity escapes before injection of the resin becomes small. If so, the gas (air) remains in the cavity, and a void called air trap may be formed. By machining the fixed-side mirror surface piece 7 and the movable-side mirror surface piece 3 to satisfy the expression (2), the void called air trap can be suppressed.

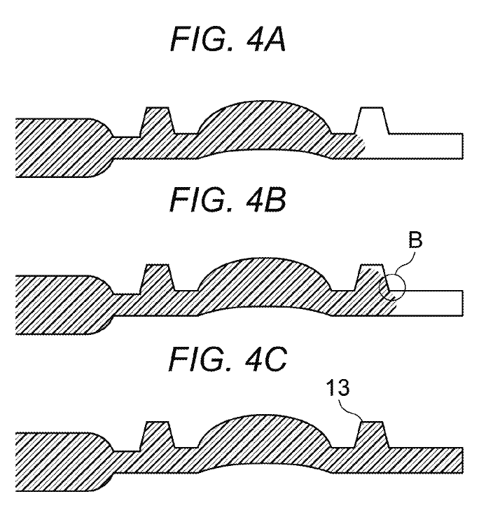

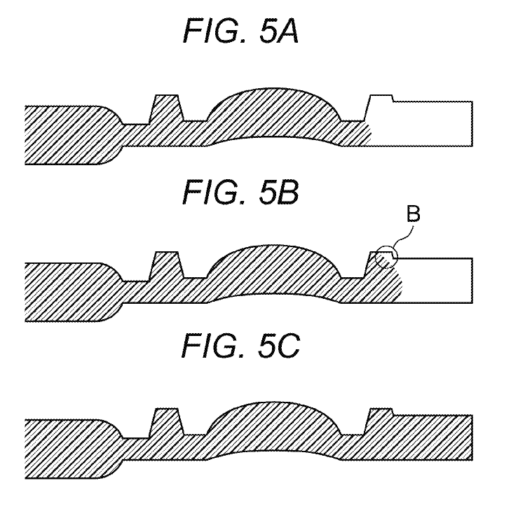

Here, a process of occurrence of the air trap will be described using FIGS. 4A to 4C, and 5A to 5C. FIGS. 4A to 4C illustrate states of a resin flow when (c−a) is 0.05 mm, (b−a)/2 is 0.125 mm, and the expression (2) is not satisfied. FIGS. 4A to 4C and 5A to 5C are schematic views of a cross section of the same place as FIG. 3. Overlapping reference numbers and description with FIG. 3 are omitted, and only different portions will be described. FIG. 4A illustrates that the front of the resin flow approaches the rib portion on the opposite gate mark side. Similarly to FIG. 3, FIGS. 4A to 4C illustrate the A-A cross section in FIG. 1. Obviously, an actual resin flow flows in a three-dimensional manner. The annular rib shape has a larger sectional area than the flange portion, and thus the resin can be easily flow. In a case where the thickness of the protruding portion is small with respect to the thickness of the rib portion, a gas 13 is left behind in the rib portion when the front of the rein flow reaches a contact point B in FIG. 4B between the rib portion and the protruding portion (in reality, in a ridge because of three dimension). This gas 13 cannot escape outside the cavity, and thus remains as a portion where the rein is not filled although the portion is pressed by resin pressure. This portion becomes the air trap. In contrast, FIGS. 5A to 5C illustrate states of the resin flow when (c−a) is 0.15 mm, (b−a)/2 is 0.125 mm, and the formula (2) is satisfied. Since the thickness of the protruding portion is sufficiently large with respect to the thickness of the rib portion, most of the gas in the annular rib shaped portion is forced out to the protruding portion side when the front of the resin flow reaches the point B in FIG. 5B, as illustrated in FIGS. 5A to 5C. As a result, the lens molded product without an air trap can be obtained, as illustrated in FIGS. 5A to 5C.

### First and Second Examples and First Comparative Example

Next, examples and a comparative example in the first exemplary embodiment of the present disclosure will be described. As the examples and the comparative example, molds were prepared such that the dimensions a, b, and c of the molded products illustrated in FIG. 3 are set to the values illustrated in Table 1. Note that the maximum thickness (the thickness on the optical axis) of the center of the molded plastic lenses was 0.8 mm.

TABLE 1
Dimensions in First and Second Exemplary Embodiments
and First Comparative Example (unit: mm)

| | a | b | c |
|---|---|---|---|
| First Exemplary Embodiment | 0.45 | 0.7 | 0.6 |
| Second Exemplary Embodiment | 0.45 | 0.7 | 0.5 |
| First Comparative Example | 0.45 | 0.6 | 0.58 |

As the material, ZEONEX E48R (registered trademark) manufactured by Zeon Corporation was used. The glass transition temperature of ZEONEX E48R is about 138° C. Therefore, the temperature of the fixed and movable mirror surface pieces of the molds was adjusted to about 130° C., using a mold temperature controller. The molds were attached to an injection molding machine and mold clamping force of 30 ton was applied to the molds. The resin material melted at 270° C. was injected and filled by the injection molding machine, and pressure keeping of 70 MPa was applied.

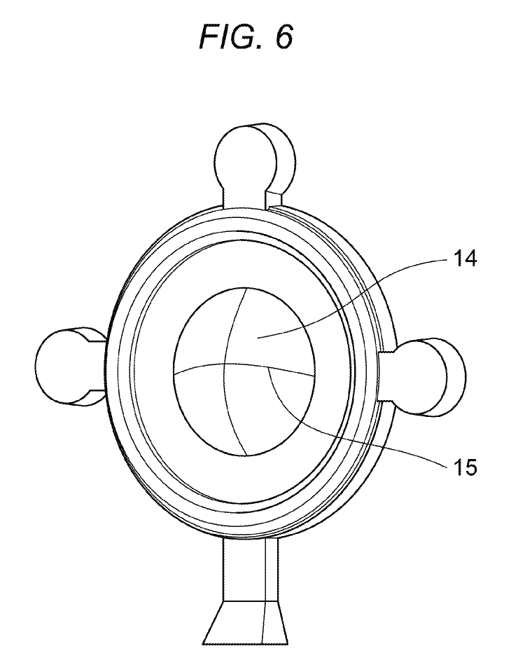

Here, a method of evaluating the lenses will be described using FIG. 6. Surfaces of the lenses are measured by a shape measuring device, and the radiuses of curvature of the lens surfaces are measured. Measuring directions are a gate mark opposite gate mark direction 14 (tentatively, an X-direction) and a direction 15 perpendicular to the gate mark opposite gate mark direction (tentatively, a Y-direction). To conduct such measurement, Form Talysurf (registered trademark) manufactured by Taylor Hobson Ltd can be used, for example. While a design value of the radius of curvature of the lens surface is R=2 mm, a difference between a radius of curvature Rx in the gate mark opposite gate mark direction and a radius of curvature Ry in the direction perpendicular to the gate mark opposite gate mark direction is required to be ±0.3 μm or less, as a specification to satisfy required performance.

The radiuses of curvature of the lenses of the first and second examples and the first comparative examples, which were obtained as described above, are listed in Table 2.

TABLE 2
Radius of Curvature in First and Second Exemplary
Embodiments and First Comparative Example

| | | | Difference |
|---|---|---|---|
| | Rx (mm) | Ry (mm) | (μm) |
| First Exemplary Embodiment | 2.00015 | 1.99992 | 0.23 |
| Second Exemplary Embodiment | 2.00016 | 1.99993 | 0.23 |
| First Comparative Example | 2.00028 | 1.99985 | 0.43 |

As illustrated in Table 2, while the first and second examples satisfied the specification, the first comparative example exceeded the specification. This is because, while the value of the dimension b was 1.4 times or more the dimension a in the first and second examples, as illustrated in Table 1, the dimension b was less than 1.4 times the dimension a in the first comparative example. Therefore, the rigidity of the rib portion was not sufficient, and the lens in the first comparative example seemed affected by non-axisymmetric properties of the mold release force and the mold release resistance.

Meanwhile, occurrence of the air trap was seen in the rib shape on the opposite gate mark side in the second example. This is because the dimension of the thickness c of the protruding portion was small, and the gas in the annular rib shaped portion did not succeed in escaping and was trapped.

### Second Exemplary Embodiment

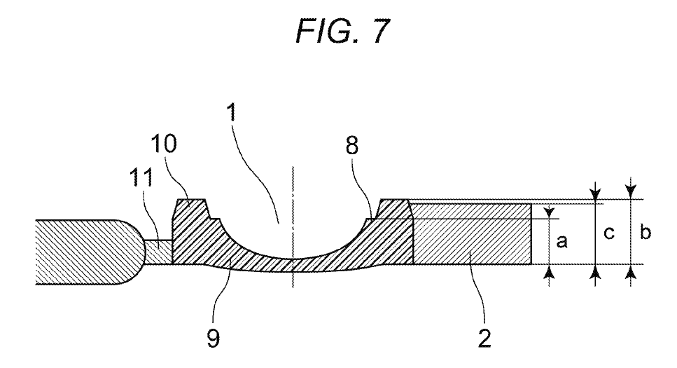

FIG. 7 is a cross-sectional view of a plastic lens of a second exemplary embodiment of the present disclosure. A portion having the same function as that of the first exemplary embodiment is denoted with the same reference sign, and description is omitted. A different point from the first exemplary embodiment is that a lens portion 9 is a concave meniscus lens. Obviously, the concave lens exhibits the same effect. As a mold configuration to obtain the plastic lens of the second exemplary embodiment, a mold similar to that of the first exemplary embodiment can be used.

Here, in a lens shape of the second exemplary embodiment, a flange portion 8 may not necessarily exist, similarly to the first exemplary embodiment. In this case, an aperture end of the lens is immediately connected to a rib portion. In the concave lens (concave meniscus lens), the lens thickness becomes maximum in the aperture end, and thus it can be said that it is more natural that the flange portion does not exist. This can be freely designed by a designer in consideration of an aspect of assembly to a lens barrel, and the like.

### Third and Fourth Examples and Second Comparative Example

Next, examples and a comparative example in the second exemplary embodiment of the present disclosure will be described. As the examples and the comparative example, the dimensions a, b, and c illustrated in FIG. 7 were set to the values illustrated in Table 3. Note that the maximum thickness of the center of the lenses was 0.4 mm.

TABLE 3
Dimensions in Third and Fourth Exemplary Embodiments
and Second Comparative Example (unit: mm)

| | a | b | c |
|---|---|---|---|
| Third Exemplary Embodiment | 0.55 | 0.8 | 0.75 |
| Fourth Exemplary Embodiment | 0.55 | 0.8 | 0.65 |
| Second Comparative Example | 0.55 | 0.7 | 0.68 |

As the material, Yupizeta EP-5000 (registered trademark) manufactured by Mitsubishi Gas Chemical Company, Inc. was used. The glass transition temperature of Yupizeta EP-5000 is about 145° C. Therefore, the temperature of the fixed and movable mirror surface pieces of the molds was adjusted to about 135° C., using a mold temperature controller. The molds were attached to an injection molding machine and mold clamping force of 30 ton was applied to the molds. The resin material melted at 260° C. was injected and filled by the injection molding machine, and pressure keeping of 60 MPa was applied.

While the design value of the radius of curvature of the lens surface is R=3 mm, the difference between the radius of curvature Rx in the gate mark opposite gate mark direction and the radius of curvature Ry in the direction perpendicular to the gate mark opposite gate mark direction is required to be ±2.5 μm or less, as the specification to satisfy the required performance.

The radiuses of curvature of the lenses of the third and fourth examples and the second comparative examples, which were obtained as described above, are listed in Table 4.

TABLE 4
Radius of Curvature in Third and Fourth Exemplary
Embodiments and Second Comparative Example

| | | | Difference |
|---|---|---|---|
| | Rx (mm) | Ry (mm) | (μm) |
| Third Exemplary Embodiment | 3.0013 | 2.9989 | 2.4 |
| Fourth Exemplary Embodiment | 3.0012 | 2.9987 | 2.5 |
| Second Comparative Example | 3.0018 | 2.9985 | 3.3 |

As illustrated in Table 4, while the third and fourth examples satisfied the specification, the second comparative example exceeded the specification. This is because, while the value of the dimension b was 1.4 times or more the dimension a in the third and fourth examples, as illustrated in Table 3, the dimension b was less than 1.4 times the dimension a in the second comparative example. Therefore, the rigidity of the rib portion was not sufficient, and the lens in the second comparative example seemed affected by non-axisymmetric properties of the mold release force and the mold release resistance.

Meanwhile, the air trap was seen in the rib portion on the opposite gate side in the fourth example. This is because the dimension of the thickness c of the protruding portion was small, and the gas in the rib portion did not succeed in escaping and was trapped. Further, in the case of the concave meniscus lens like FIG. 7, and where the thickness of the rib portion and the thickness of the lens center exist in the opposite directions with respect to the optical axis, the resin flows in the lens portion is more likely to flow into the side where no annular rib shape exists and the lens thickness exists. Therefore, the resin less easily flows in the rib portion and the air trap easily occurs. In the third example, the thickness of the protruding portion was sufficiently large with respect to the thickness of the annular rib shape, and thus the lens molded product without an air trap was able to be obtained.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-078358, filed Apr. 8, 2016, which is hereby incorporated by reference herein in its entirety.

What is claimed is:

1. A plastic lens comprising:
a lens portion;
a rib portion formed outside the lens portion; and
a protruding portion protruding outside the rib portion, wherein
a thickness of the rib portion is 1.4 times or more a thickness of an aperture end of a lens surface of the lens portion.

2. The plastic lens according to claim 1, wherein
a thickness c of the protruding portion satisfies an expression below:
(c−a)≧(b−a)/2
where the thickness of the aperture end is a and the thickness of the rib portion is b.

3. The plastic lens according to claim 1, wherein
a diameter of the lens portion is 10 mm or less, and a minimum thickness is 0.5 mm or less.

4. The plastic lens according to claim 1, wherein
the protruding portion has a columnar shape.

5. The plastic lens according to claim 1, wherein
an area of the protruding portion, the area being joined with the rib portion, has a length from 3% to 10%, both inclusive, with respect to a length of an outer periphery of the rib portion as viewed from an optical axis direction.

6. The plastic lens according to claim 1, further comprising
a flange portion outside the rib portion, wherein
the protruding portion is joined with the flange portion, an area joined with the flange portion has a length from 3% to 10%, both inclusive, with respect to a length of an outer periphery of the flange portion as viewed from an optical axis direction.

7. The plastic lens according to claim 1, further comprising
a flange portion between the lens portion and the rib portion.

8. The plastic lens according to claim 1, wherein
one protruding portion is included on an opposite gate mark side.

9. The plastic lens according to claim 1, wherein
three protruding portions are included.

10. A method of manufacturing a plastic lens including, a lens portion, a rib portion formed outside the lens portion, and a protruding portion protruding outside the rib portion, wherein a thickness of the rib portion is 1.4 times or more a thickness of an aperture end of a lens surface of the lens portion, the method comprising:
bringing a fixed-side piece and a movable-side piece, in which a shape for transferring the plastic lens is formed, to face each other to form a cavity; and
injecting a resin into the cavity to mold the plastic lens.

11. The method of manufacturing the plastic lens according to claim 10, wherein
the shape for transferring the plastic lens is machined by turning machining.

12. An optical instrument comprising
a mounted plastic lens including:
a lens portion;
a rib portion formed outside the lens portion; and
a protruding portion protruding outside the rib portion,
wherein a thickness of the rib portion is 1.4 times or more a thickness of an aperture end of a lens surface of the lens portion.
